(19) United States
(12) Patent Application Publication
(10) Pub. No.: US 2014/0120243 A1
(43) Pub. Date: May 1, 2014

(54) SYNTHESIS AND PROCESSING OF NEW SILSESQUIOXANE/SILOXANE SYSTEMS

(71) Applicant: MAYATERIALS, INC., Ann Arbor, MI (US)

(72) Inventors: Richard M. LAINE, Ann Arbor, MI (US); Michael Z. ASUNCION, Ann Arbor, MI (US); David J. KRUG, Ann Arbor, MI (US)

(73) Assignee: MAYATERIALS, INC., Ann Arbor, MI (US)

(21) Appl. No.: 13/665,138

(22) Filed: Oct. 31, 2012

(51) Int. Cl. C08G 77/18; C07F 7/21

(52) U.S. Cl. CPC C08G 77/18; C07F 7/21
USPC 427/58; 528/37; 106/287.14; 556/461; 556/460; 264/571

(57) ABSTRACT

A method of forming a silsesquioxane/Q/siloxane polymer or oligomer system used to form coatings or monoliths, includes the step of mixing silsesquioxane, siloxane and alkoxysilane components having structures as presented below in ratios as presented below with a soluble F⁻ catalyst and water in a suitable solvent so that on stirring at temperatures of −20° to approximately 100° C. all of the components dissolve producing a solution. A soluble oligomer is formed in equilibribum with single molecules with specific structures including [RSiO_{1.5}]ₓ[R′MeSiO]_{y}[R′Me₂SiOSiO_{1.5}]_{z} (where R═R′ or R″ or R¹ or R² as denoted below) and where x, y and z are mole fractions whose sum is equal to one.

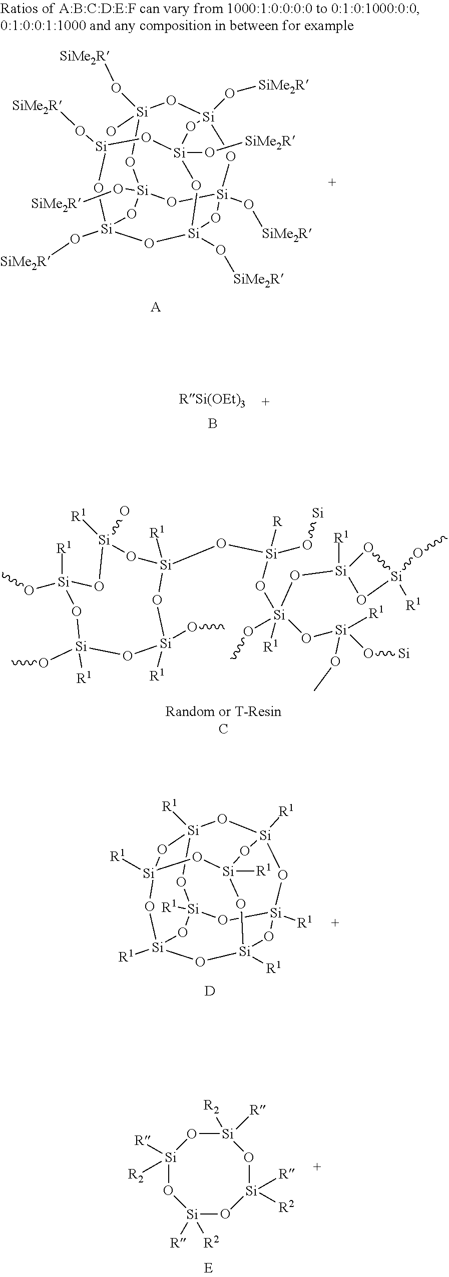

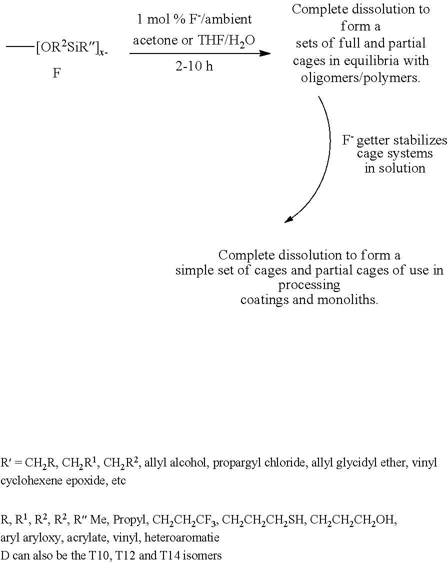

### GOVERNMENT SUPPORT

This invention was made with government support under W911QY-08-C-0098 awarded by the Army Research Laboratory, Natick. The Government may have certain rights in the invention.

### TECHNICAL FIELD OF THE INVENTION

The present disclosure relates to methods for making and optimizing functionalized silsesquioxane/siloxane chemical and/or physical mixtures to tailor their properties for use in forming coatings and monoliths for specific mechanical, photonic and/or electronic applications.

### BACKGROUND OF THE INVENTION

This section provides background information related to the present disclosure which is not necessarily prior art. Silicone resins are used in numerous applications ranging from sealing kitchen and bathroom surfaces, to soft contact lenses, to novel antireflective coatings, to low dielectric constant materials for interlayer dielectrics in multilayer integrated chip manufacturing to name just a few.

They are formulated using a wide variety of components and chemistries that typically involve the hydrolysis of various components RSiX₃ (X═Cl, OR′, OAc), R₂SiCl₂, and R₃SiCl in selected ratios (where R═H, CH₃, Et, propyl, CH₂CH₂CF₃, CH₂CH₂CH₂Cl, CH₂CH₂CH₂SH, CH₂CH₂CH₂NH₂, CH₂CH═CH₂, CH═CH₂, phenyl for example). SiCl₄ can also be added.

The purpose of the hydrolysis of these mixtures is to tailor the properties of the resulting material or material precursor to those needed for a specific application. The hydrolysis process often results in the production of unwanted, toxic and polluting HCl if X═Cl, which must be removed. In many instances, species like HSiMe₂ or [-MeHSi—O]x- are added so that in a second or third step, hydrosilylation can be used to further tailor the properties of the material or material precursor as suggested in reactions (1) and (2) [R=phenyl] in FIG. 23, which are not meant to be limiting.

Once formulated, these systems cannot be modified for example to add more [-Me₂SiO—], RSiO_{1.5} (T or SQ) or RMe₂Si—O—SiO_{1.5} (Q) units or to add more or different CH₂CH₂R groups. Furthermore, these compounds are typically oligomeric resins with molecular weights of a few hundreds to thousands or even millions of Daltons. Once formed it is quite difficult to manipulate their inherent viscosities or adhesive properties or their thermal stabilities. Finally there is no indication in the literature that they can be recycled.

We have discovered a simple catalyst system that can be used to form families of silsesquioxane (RSiO_{1.5}=SQ)/Q (RMe₂Si—O—SiO_{1.5}=Q)/siloxane/systems starting from a wide variety of SQ cages or resins, Q cages or resins, alkoxysilane monomers, such that the properties of the resulting SQ/Q/siloxane system can be tailored to give recyclable SQ/Q/siloxane resins and or simple cage-like SQ/Q/siloxane oligomers. The properties of these materials or material precursors can be tailored over a wide range by simple choice of the overall composition of the starting components. Furthermore, they can be modified after formation to adjust their properties incrementally or extensively.

The resulting monomer units and/or resin systems can be used to form novel coatings or monolithic materials with high thermal and environmental stability, controlled hardness, refractive index, transparency, toughness, degree of hydrophobicity/hydrophilicity, adhesion to specific surfaces and the potential to be photolytically and/or chemically crosslinked for example. In instances where the compounds are not extensively covalently crosslinked with complex carbon-carbon bond interactions, the coatings and/or monoliths can be redissolved and recycled or modified in the original solvent in the presence of the initial catalyst despite exposure to temperatures exceeding 250° C.

All of these possibilities arise because of the use of simple and harmless fluoride (F⁻) catalysts. We have discovered that silicon centers in silicone resins, SQ and Q cages, even those with very poor solubility, will dissolve in most organic solvents (acetone, toluene, ether, THF) in the presence of sometimes less than 1% of an ammonium fluoride. Two such fluorides are [(CH₃)₄NF] and {[(CH₃)₃C]₄NF} called for short TMAF and TBAF.

Apparently, in the presence of the fluoride ion, F⁻, the silicon-oxygen bonds are cleaved and reformed at great rates even at ambient temperature. The most general description of the synthesis process of the present invention is given in FIG. 24. In this process the starting components can be chosen from a wide set of Q resins or cages (Q=8, 10), T resins or polyhedral cages (T=8, 10, 12, 14 etc), and/or simple alkoxysilanes such as triethoxy or trimethoxy if some water is added to promote hydrolysis. The resulting cage or resin systems can be used for coating applications, casting and curing monoliths or as additives. In some instances, the cages and the resins are in equilibrium in dilute solution, which on concentration tends to cause the formation of more resin at the expense of the simple cages.

FIG. 24 shows possible components that can be used in the formulation of a novel SQ/Q/siloxane resin or cage mixtures of use as materials precursors or as materials for selected applications including coatings, monolith formation or as additives etc, according to the present invention.

The novelty of the invention is seen based on selected background literature. Thus, for example Bassindale et al discovered that it is possible to hydrolyze alkoxysilanes using F⁻ sources at nearly molar amounts of F⁻ to produce cage compounds in low 5-40% yields (reaction 3 in FIG. 25) in reference 1 and in modest to good yields in reference 2.^{1,2} In reference 1, they use F⁻ in a stoichiometric excess in all examples, in reference 2 they use greater than 50 mole % F. In both instances they use tBu₄NF as the catalyst. In reference 2, they find that they can synthesize the T₈ compounds starting from trialkoxyalkylsilanes in moderate to good yields except for the methyl, vinyl, t-Butyl cages where the yields of the T₈ compounds are very poor. They state: “Thus, we believe that the fluoride ion acts as a general base enabling hydroxide ion to attack the triethoxysilane to form the silanol.”

FIG. 25 shows an example of a reaction according to Reference 1. They further note that: “For example, vinyltriethoxysilane gave virtually no T8 cage (1% yield) but did allow the isolation of 11% (yield) T10 and 25% (yield) T12 cage.”

This is similar to the yields seen in reaction (3). In contrast, we have concluded that F⁻ itself is the true catalyst and does not act as a base. We also find that F⁻ can be used in as little as 0.25 mol % to effect the same reactions. Furthermore, according to References 3 to 5, we find that by removing the F⁻ from solution we can obtain the same vinyl T₁₀ and vinyl T₁₂ in quantitative (100%) yields.³⁻⁵ Reference 5 is U.S. Patent Application R. M. Laine, S. Sulaiman, “Properties tailoring in silsesquioxanes via a novel inter-conversion processes,” U.S. Patent to R. M. Laine, S. Sulaiman, “Properties tailoring in silsesquioxanes via a novel inter-conversion processes,” U.S. Pat. No. 8,053,514, Nov. 8, 2011 which we incorporate herein as prior art.

### REFERENCES

1. Z. Liu, A. R. Bassindale, P. G. Taylor, “Synthesis of SilsesquiOxane Cages from Phenyl-cis-tetrool, 13-DiVinyltetraethoxydisilOxane and Cyclopentyl Resins,” Chem. Res. Chinese U. 20 433-436 (2004).
2. A. R. Bassindale, Z. Liu, I. A. MacKinnon, P. G. Taylor, Y. Yang, M. E. Light, P. N. Horton, M. B. Hursthouse, “A higher yielding route for T8 silsesquioxane cages and X-ray crystal structures of some novel spherosilicates, Dalton Transactions 2945-2949 (2003).
3. M. Ronchi, S. Sulaiman, N. R. Boston, R. M. Laine, “Fluoride catalyzed rearrangements of polysilsesquioxanes, mixed Me,Vinyl T₈, Me,Vinyl T₁₀ and T₁₂ cages,” Applied Organometallic Chemistry, 24, 551-557 (2010).
4. M. Z. Asuncion, and R. M. Laine, “Fluoride Rearrangement Reactions of Polyphenyl- andPolyvinylsilsesquioxanes as a Facile Route to Mixed Functional Phenyl,Vinyl T₁₀ and T₁₂Silsesquioxanes,” J. Am. Chem. Soc. 2010, 132 3723-3736.
5. R. M. Laine, S. Sulaiman, “Properties tailoring in silsesquioxanes via a novel inter-conversion processes,” U.S. patent application Ser. No. 12/609,708, US 2010/0222503 A1

### SUMMARY OF THE INVENTION

What is not evident in the above prior art and is not obvious to someone of average skill (bachelors degree in chemistry and two years training in silicon chemistry) is that it is possible to coincidentally use mixtures of a wide variety of SQ and Q resins, cages, siloxanes, and/or alkoxysilanes (acetoxy, propanoxy, etc) to produce a very wide variety of new resin or cage systems simply by using catalytic amounts of a soluble F⁻ source with trace amounts of water that can be left in to give resins of the composition of the starting component functionalities or to remove this F⁻ source to produce mixed functionality cage systems with the same compositions. Some examples of the types of cage systems that we have identified can be produced are seen in Examples 2-5.

We submit that it is not obvious that PDMS and cyclic siloxanes will mix and equilibrate with Tₙ cages or resins nor is it obvious that Q_{8,10} cages or resins can also be introduced. We submit that Si—H bonds are likely to react to trap F⁻ as Si—F bonds. We also suggest that the fact that Si—F bonds in some instances may form in the catalytic process and despite their having one of the highest bond energies know for common elements can also be displaced and this is one possible mechanism whereby the catalytic exchange processes take place.

### BRIEF DESCRIPTION OF THE DRAWINGS

FIG. 1 shows a schematic of F⁻ catalyzed polymerization of OPS and ^{Me}D₄, according to the present invention;

FIG. 2 shows a MALDI-TOF mass spectral analysis of Example 3 of a 60:40 molar ratio of [PhSiO_{1.5}]₈:[Me₂SiO]₄ according to the present invention;

FIG. 3 shows a MALDI-TOF mass spectral analysis of Example 4 of a 20:80 molar ratio of [PhSiO_{1.5}]₈:[Me₂SiO]₄ according to the present invention;

FIG. 4 shows selected proposed structures for the various ions seen in FIGS. 2 and 3, according to the present invention;

FIGS. 5a and 5b show monoliths, thin films and coatings of OPS/^{Me}D₄ T-resins according to the present invention, wherein FIG. 5a shows 1:1 OPS/^{Me}D₄ cast and air hardened and FIG. 5b shows 2:3 mol % OPS/^{Me}D₄ glass coated (20 μm);

FIGS. 6a and 6b show the use of a refractive index matched OPS/Me₈D₄/S-fiber glass system that gives a transparent composite after casting and curing by heating mildly to temperatures between 10° and 300° C., according to the present invention, wherein FIG. 6a shows 2-plies of S-glass and FIG. 6b shows 2-ply S-glass FRC with indexed-matched OPS/Me₈D₄ matrix;

FIG. 7 shows 2-ply glass FRC (50/50 mol % OPS/Me₈D₄) partially submerged in acetone for 6 h, according to the present invention;

FIGS. 8a to 8c show examples of hydrophobicity of OPS/^{Me}D₄ coatings according to the present invention, wherein FIG. 8a shows 2:3 mol % OPS/^{Me}D₄ coatings on glass, FIG. 8b shows 2:3 mol % OPS/^{Me}D₄ coatings on Al 5083 and FIG. 8c shows 2:3 mol % OPS/^{Me}D₄ coatings on untreated Al 5083;

FIGS. 9a to 9c show additional examples of hydrophobicity of OPS/^{Me}D₄ coatings according to the present invention, wherein FIG. 9a shows 2:3 mol % ratio OPS/^{Me}D₄ coatings on Al 5083 being applied by hand (cloth), FIG. 9b shows hydrophobic given by the application shown in FIG. 9a and FIG. 9c shows superhydrophobic surfaces on silica cores;

FIGS. 10a to 10d show examples of corrosion resistance of OPS/^{Me}D₄ coatings according to the present invention, wherein FIG. 10a shows OPS/^{Me}D₄ with rare earth corrosion inhibitor on Al 5083 after 200 h corrosion test, FIG. 10b shows 10× magnification of score shown in FIG. 10a, FIG. 10c shows uncoated Al 5083 after 200 h corrosion test, and FIG. 10d shows 10× magnification of score shown in FIG. 10c;

FIG. 11 shows synthesis of thiol cages via acid hydrolysis/condensation and F⁻ rearrangement, according to the present invention;

FIGS. 12a and 12b show that 5-20 mol % [vinylSiO_{1.5}]_{10/12}—[HSCH₂CH₂CH₂SiO_{1.5}]ₙ mixtures undergo rapid, ambient F⁻ catalyzed exchange with OPS/^{Me}D₄ introducing controlled compositions, according to the present invention, wherein FIG. 12a shows one example and FIG. 12b shows another example;

FIG. 13 shows MALDI-TOF mass spectral analysis of Example 2 according to the present invention;

FIG. 14 shows MALDI-ToF mass spectral analysis of Example 3 according to the present invention;

FIG. 15 shows structures in Ph/^{Me}D according to the present invention;

FIG. 16 shows ¹H NMR analysis of the reaction solution gives the spectra according to the present invention;

FIG. 17 shows ¹³C NMR analysis of the reaction solution gives the spectra according to the present invention;

FIG. 18 shows MALDI-ToF mass spectral analysis of the reaction solution according to the present invention;

FIG. 19 shows suggested structures to account for the peaks seen in FIG. 18 according to the present invention;

FIG. 20 shows MALDI-TOF mass spectral analysis of Example 13 according to the present invention;

FIG. 21 shows structures of Example 13 according to the present invention;

FIG. 22 shows compositions of Example 13 according to the present invention;

FIG. 23 shows examples of reactions of hydrosilylation;

FIG. 24 shows possible components that can be used in the formulation of a novel SQ/Q/siloxane resin or cage mixtures of use as materials precursors or as materials for selected applications including coatings, monolith formation or as additives etc, according to the present invention; and

FIG. 25 shows an example of a reaction according to Reference 1.

### PREFERRED EMBODIMENT OF THE PRESENT INVENTION

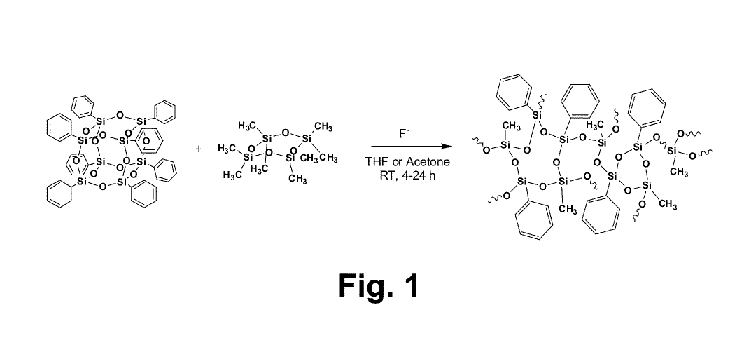

Using the subject invention, we have extended this work finding that mixtures of 5-70 mol % OPS, (PhSiO_{1.5})₈ copolymerize with octamethylcyclotetrasiloxane (^{Me}D₄) using 0.25-2 mol % F⁻ to form random-structured SQ “T-resin siloxanes copolymers or resins” with stoichiometric control of phenyl:methyl ratios (FIG. 1). The T-resins are normally defined as oligomeric or polymeric species that contain [RSiO_{1.5}] or RSiO(OR) units, where R═H, or other alkyl, aryl, ether, ester, alcohol, heteraromatic or other group. In some instances, T-resins can include some [R′₂SiO] and [R′₃SiO] groups, where R′═R or mixed groups. In still other instances, these same resins can contain Q groups which consist of [Si(O)₄] units. It is also possible to introduce [R′₃SiOSiO_{1.5}] (Q) groups to common “T” resins after or during initial synthesis.

Highly insoluble OPS dissolves in acetone or THF after stirring at RT for 2 h. This is very unusual because neither OPS nor the Me₈D₄ are normally soluble in acetone let alone at RT. Low mol % OPS (high mol % ^{Me}D₄) films, monoliths or coatings are transparent, flexible, and soft while the opposite ratios give transparent, rigid, and hard films, monoliths or coatings. Retaining the F⁻ (levels less than in toothpaste) leads exclusively to SQ resins with mixed functionalities (see below) without unreacted “monomers” in a “one-pot” route at ambient in 2-48 h. Alternatively, trapping the F⁻ provides mixed functional cages.

FIG. 1 shows schematic of F⁻ catalyzed polymerization of OPS and ^{Me}D₄. OPS is formed in >90% yield from the base-catalyzed hydrolysis/condensation of phenyltrichlorosilane in EtOH. It is a white, highly crystalline solid that decomposes above 500° C. It is insoluble in almost all common organic solvents, limiting the derivatives that can be prepared directly from them. However, OPS (or its T₁₀, T₁₂ or other Tₙ analog) solubilizes readily as it reacts with F⁻ during rearrangement. The by-product of the OPS synthesis, PPS, can also be recovered and used as a reactant in rearrangement/polymerization reactions, essentially making the conversion of phenyltrichlorosilane into SQ resins very near 100%.

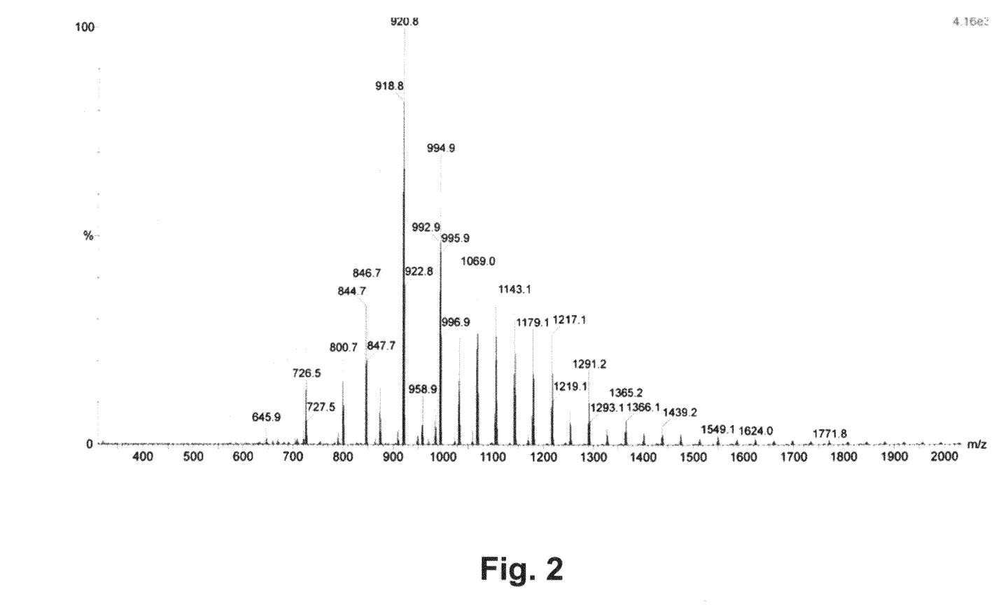

The species that form in solutions from the reaction of FIG. 1 include but are not limited to those seen by matrix assisted laser desorption time of flight mass spectroscopy as shown in FIGS. 2-4.

FIG. 2 shows MALDI-TOF analysis of a 60:40 molar ratio of [PhSiO_{1.5}]8:[Me₂SiO]₄ in Example 3. Note that MALDI-ToF mass spectral peak positions often differ by up to ±2 mass units even with instrument calibration.

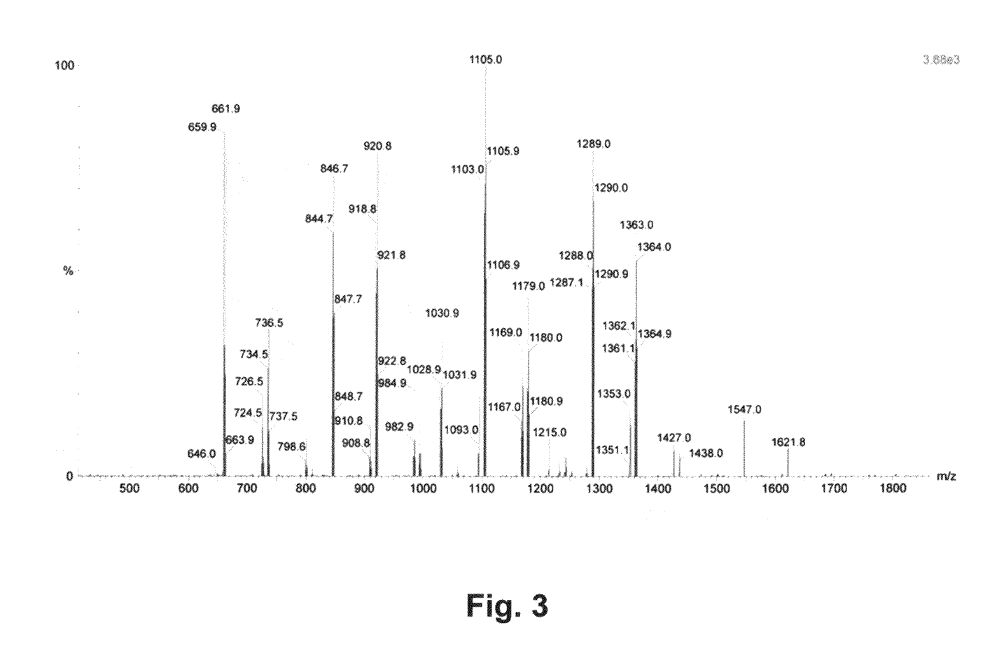

FIG. 3 shows MALDI-TOF analysis of a 20:80 molar ratio of [PhSiO_{1.5}]₈:[Me₂SiO]₄ in Example 4. Note that MALDI-ToF mass spectral peak positions often differ by up to ±2 mass units even with instrument calibration.

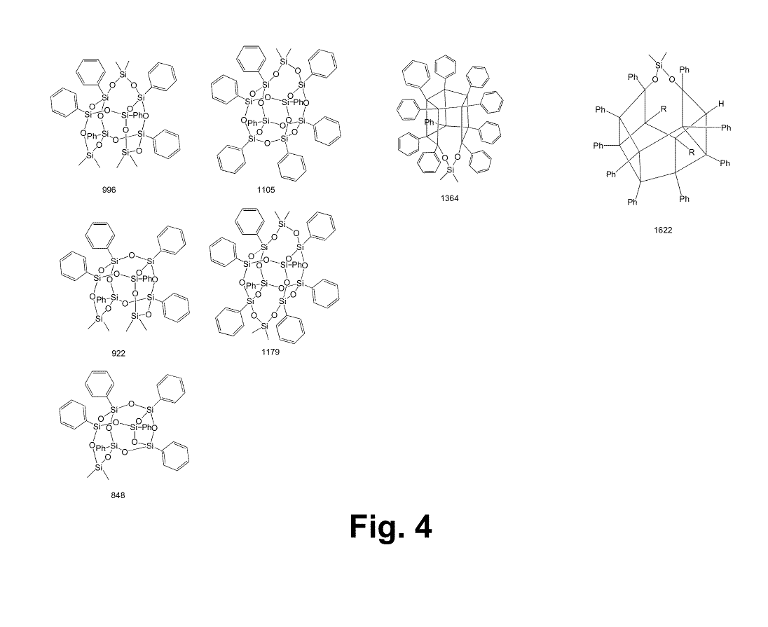

FIG. 4 shows selected proposed structures for the various ions seen in FIGS. 2 and 3, which are not meant to be comprehensive nor to identify all possible isomers of the various components.

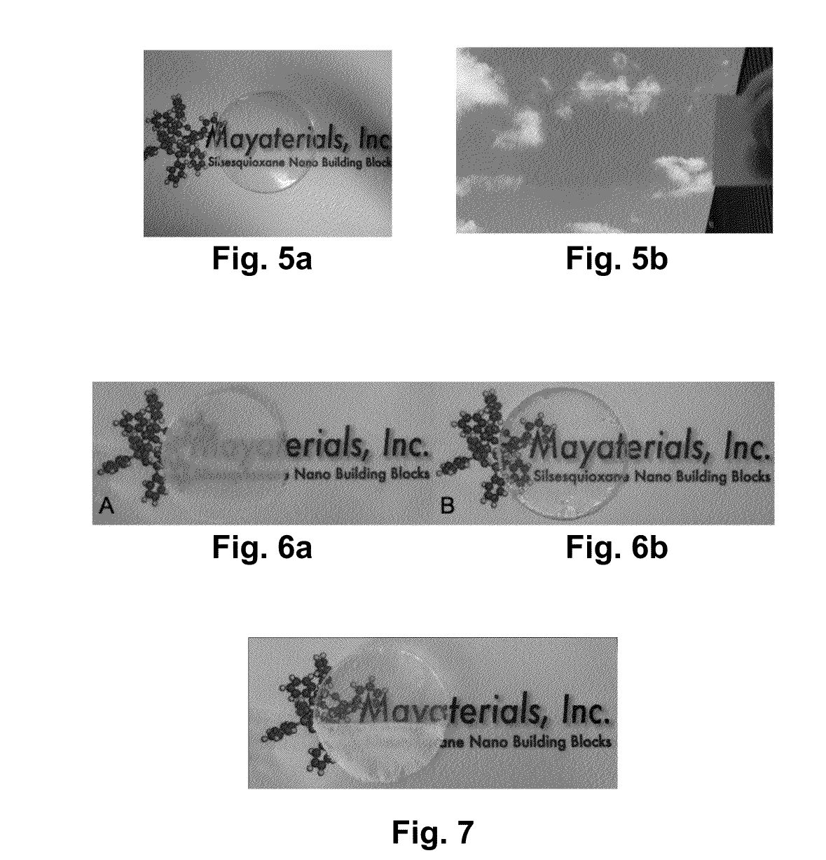

Monoliths, thin films and coatings of OPS/^{Me}D₄ T-resins (FIG. 5) harden at ambient T in a few hours but can be heated up to 225° C. to hasten the process. They are transparent, easily colored, and stable with T_{d5%} over 400° C. (for 50 mol % OPS resins), making them quite suitable for high T applications. Their high T stability is controlled mainly by phenyl group composition in the T-resin, allowing one to tailor properties over a broad range simply by controlling the amounts of starting materials. These OPS/^{Me}D₄ materials can be tailored for hardness. Thin films (0.5-2 μm) of spray/dip coated 2-3 mol % OPS/^{Me}D₄ on metal/glass when heated at 65° C. (2 h) offer hardnesses 9H (ASTM D 3363). 5-20 wt % Aerosil SiO₂ can also be introduced to impart abrasion resistance, roughness for superhydrophobicity, opacity, etc. TiO₂ could be incorporated into these systems for similar purposes. Addition of Uvinol D-50 (2,2′,4,4′-tetrahydroxybenzophenone), a commercially available UV A/B broad band filter (280-400 nm) provides Uv blocking films, coatings and/or monoliths.

FIG. 5a shows 1:1 OPS/^{Me}D₄ cast and air hardened and FIG. 5b shows 2:3 mol % OPS/^{Me}D₄ glass coated (20 μm).

These same compounds can be used to cast and index match glass fibers thus, FIGS. 6a and 6b show the use of a refractive index matched OPS/Me₈D₄/S-fiber glass system that gives a transparent composite after casting and curing by heating mildly to temperatures between 10° and 300° C.

FIG. 6a shows 2-plies of S-glass and FIG. 6b shows 2-ply S-glass FRC with indexed-matched OPS/Me₈D₄ matrix.

As noted above, despite heating to temperatures greater than or equal to 200° C., the presence of small amounts (0.05% w/w) of catalytic F⁻ remaining in the polymer upon hardening also allows the coatings to be recycled and/or repaired. The matrix of the composite shown in FIG. 6b can be redissolved as seen in FIG. 7.

FIG. 7 shows 2-ply glass FRC (50/50 mol % OPS/Me₈D₄) partially submerged in acetone for 6 h. Approximately half of the matrix was dissolved away, exposing glass fibers.

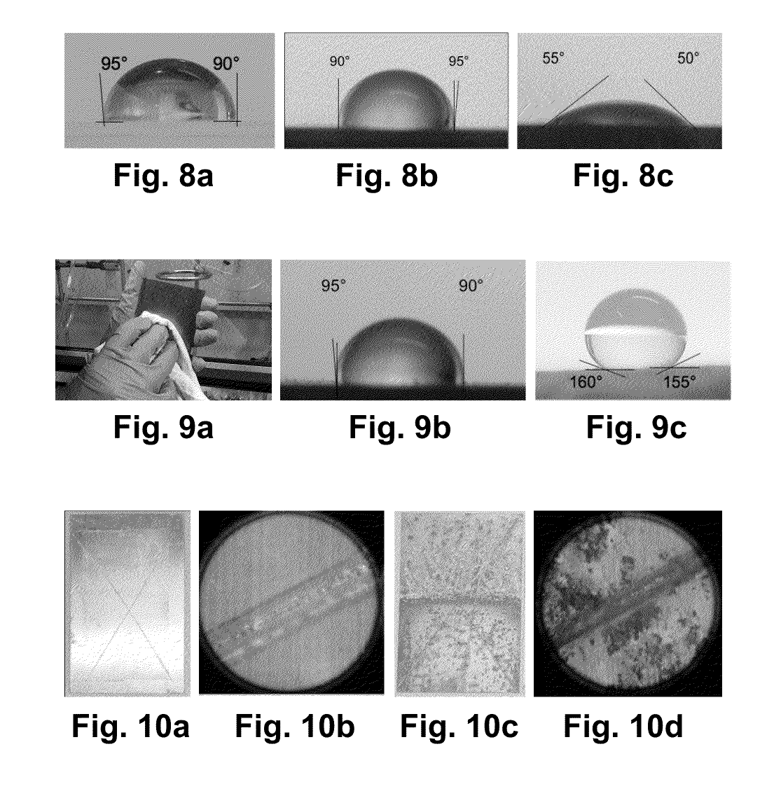

OPS/^{Me}D₄ coatings are also hydrophobic. Dip- or spray coated glass on marine-grade Al 5083 offer water contact angles of 90-95° , as shown in FIGS. 8a to 8c. Alternately hydrophobicity to 110° is obtained using [Me(CF₃CH₂CH₂)SiO]₄ in place of ^{Me}D₄. These coatings can also be applied by simple brush/wipe-on by hand (FIG. 9a) with identical results (FIG. 9b). Similar results were found using Al 6061, 7075, and 2024 substrates. Hydrophobicity is very desirable for thin film coatings as it often indicates potential for non-stick surfaces as well as self-cleaning, icephobicity, and anti-corrosion properties.

As mentioned above, nanoparticles may be added to the coating system to introduce surface roughness to the substrate, resulting in a superhydrophobic surface. Similarly OPS/[Me(CF₃CH₂CH₂)SiO]₄ coatings (or other partially or fully fluorinated siloxanes, R_{f}-alkoxysilanes etc) on silica cores with rough surfaces give water contact angles >155° (FIG. 6c).

2:3 mol % OPS/^{Me}D₄ coatings on glass in FIG. 8a and on Al 5083 in FIG. 8b show high hydrophobicity compared to untreated Al 5083 in FIG. 8c.

As shown FIGS. 9a to 9c, 2:3 mol % ratio OPS/^{Me}D₄ coatings on Al 5083 applied by hand (cloth) give hydrophobic and superydrophobic surfaces on silica cores.

OPS/^{R}D₄-type systems harden as a random network without free monomer, and are thus expected to form smooth, void-free surfaces unless nanoparticles are specifically added that are unlikely to physically collect rust or biofoul as it is also well known that biorganisms do not settle easily on smooth or superhydrophobic (added nanoparticles) surfaces.

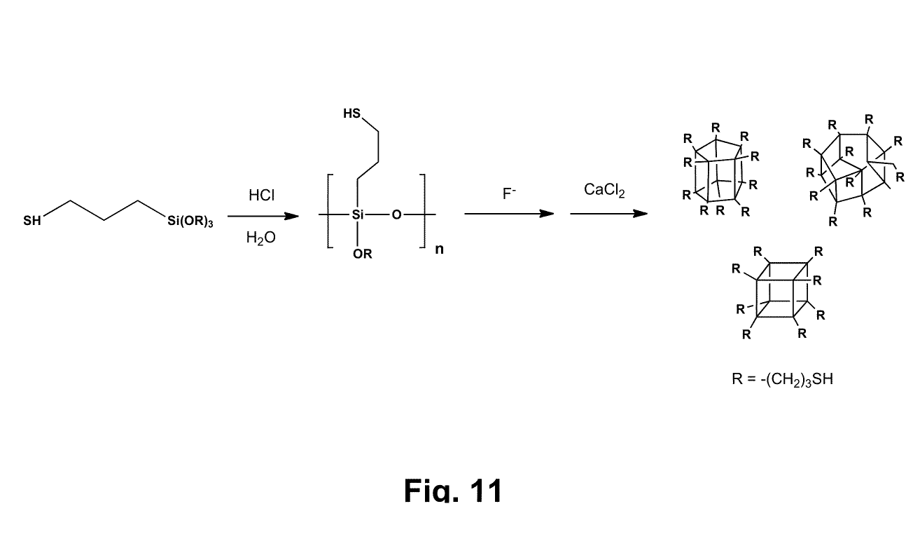

Corrosion studies performed using standard Mil-Spec methods show that the addition of rare earth oxides of cerium and zirconium gave much improved corrosion resistance. When added to OPS/^{Me}D₄ coatings it greatly increases the corrosion resistance of A15083 with <1 wt % of the rare earths thus keeping costs low. FIG. 10a below shows a coated panel compared to an uncoated piece of Al (FIG. 10b) after 200 h in an aerated 5% saltwater bath. In corrosion studies funded by the Air Force, it was determined that determined that this test replicates a salt spray chamber in accordance with ASTM B117.

FIG. 10a shows OPS/^{Me}D₄ with rare earth corrosion inhibitor on Al 5083 after 200 h corrosion test, FIG. 10b shows 10× magnification of score shown in FIG. 10a, FIG. 10c shows uncoated Al 5083 after 200 h corrosion test, and FIG. 10d shows 10× magnification of score shown in FIG. 10c.

Thermogravimetric analysis shows that the coatings or monoliths decompose without melting above 400° C., indicative of true thermosetting materials. Traditional thermosets are typically recycled as fillers (by physically shredding and/or grinding) or thermally or chemically broken down into monomers, though at the expense of high energy or prohibitive chemical costs. In contrast, OPS/^{Me}D₄ coatings, dissolve readily in a small amount of suitable solvent in 4-8 h. In addition, spray coating or brush-on of additional material should easily address repairs to damaged coatings. The ease of this process should allow in service repairs. Finally, as a point for comparison, the amount of F⁻ in toothpaste (as NaF) in the U.S. is typically 0.22-0.24% w/w or about 5× more concentrated than for our systems.

Further functionality can be introduced if OPS/^{Me}D₄ systems are reacted with other functionalized SQs including for example RHA-derived “Q₈” octaglycidyl (OG) SQs (see Scheme 1, Q system where R=Glycidyl) via F⁻ catalyzed exchange, providing resins with reactive sites for further crosslinking, i.e. with amines. High crosslink densities give OG/amine (e.g. OAPS, octaminophenyl SQ) resins high strength (E=2.4-3.5 GPa) and fracture toughness (K_{1c}=1.8). Similarly, methylacrylate and even vinyl and SH groups can be introduced using F⁻ catalysis. Thus HS(CH₂)₃Si(OCH₂CH₃)₃, or [HSCH₂CH₂CH₂SiO_{1.5}]ₙ can be used to form analogous -SH cages as suggested in FIG. 11.

FIG. 11 shows synthesis of thiol cages via acid hydrolysis/condensation and F⁻ rearrangement.

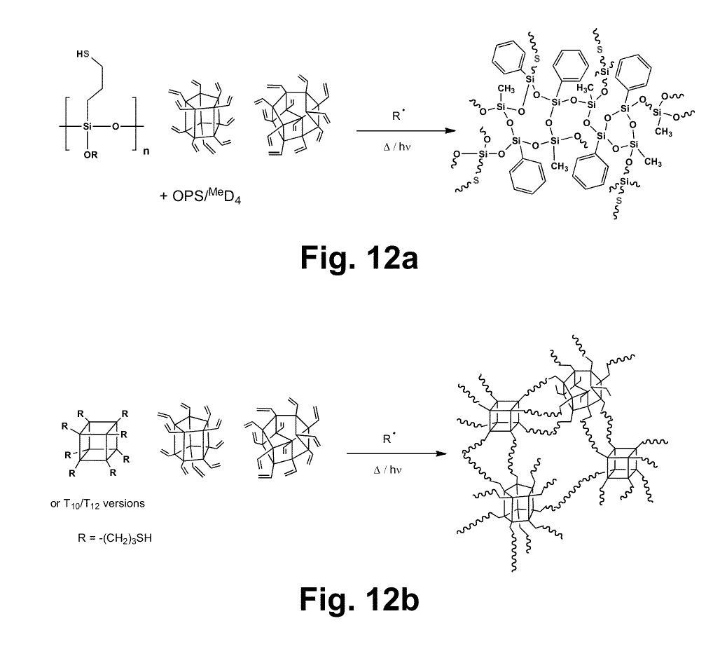

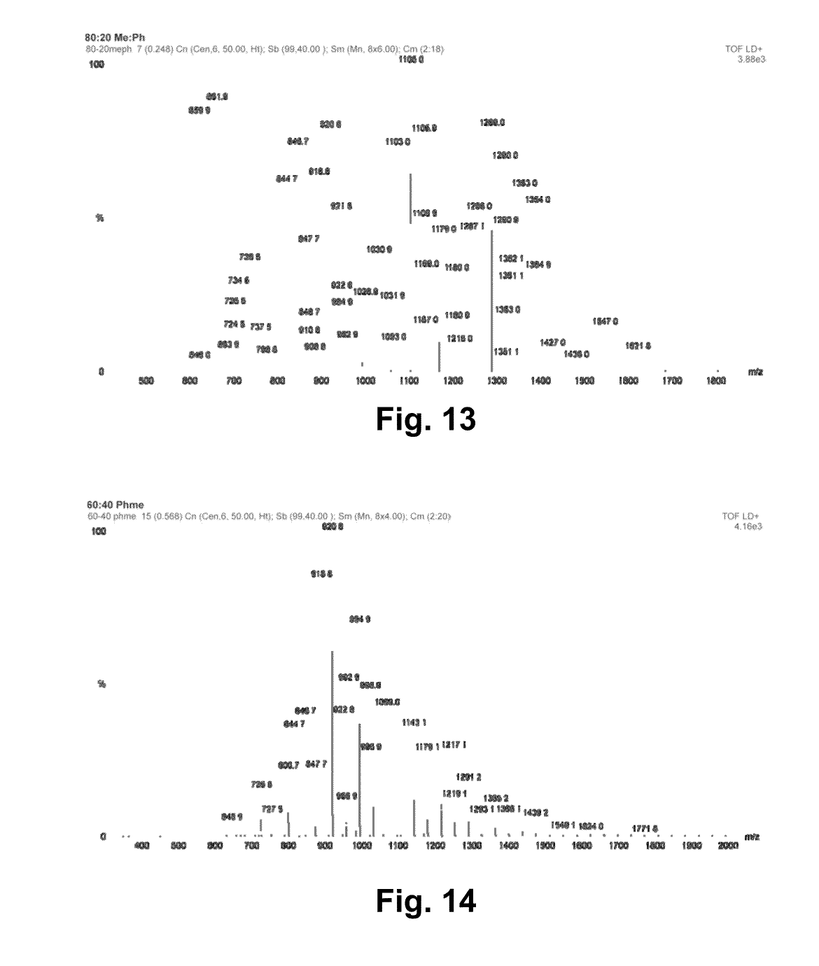

We recently discovered that 5-20 mol % [vinylSiO_{1.5}]_{10/12}-[HSCH₂CH₂CH₂SiO_{1.5}]ₙ mixtures (FIGS. 12a and 12b) undergo rapid, ambient F⁻ catalyzed exchange with OPS/^{Me}D₄ introducing controlled quantities of —SH and vinyl. These species readily form —S—CH₂CH₂- crosslinks on UV (blue light) irradiation or thermal radical initiation providing a mechanism for controlling crosslink densities and therefore mechanical properties. It has been reported that vinylsilanes readily react with thiols using broadband, low-power commercial sunlamps (without exclusion of air), making these systems feasibly crosslinkable simply by exposure to ambient sunlight, negating the need for specialized equipment (i.e. UV lamps) to cure.⁵⁷

As shown in FIG. 12a, Thiol-functionalized SQ (also Q not shown) oligomers/polymers and vinyl T₁₀/T₁₂ cages are added to OPS/^{Me}D₄ systems or, as shown in FIG. 12b, reacted independently increase crosslink density via thermal or UV-activated hydrothiolation.

In general, this basic polymer system can be modified in multiple ways to add crosslink density to soft materials to introduce greater toughness and tear strength. Other moieties can be added to tailor resistance to adhesion by marine organisms (e.g. introducing a variety of radical traps including dibutyl phenols, EDTA, TEMPO, etc.) to disrupt crosslinking mechanisms to Al, for example, SQ resins are also resistant to typical solvents and changes in pH; their high abrasion resistance (hardnesses to 2.5 GPa) should imbue compatibility with shipboard cleaning regimens, likely reducing the time/effort involved in cleaning and ultimately extending coating lifetimes.

Thus, it is possible to make mixed thiol-vinyl SQ/siloxane systems that will self cure using ene-thiol reactions where both the ene (vinyl) and the thiol are introduced to the same molecules at temperatures where the ene-thiol reaction will not proceed. These materials are thermoset systems that do not off-gas anything. Alternately, they can be crosslinked photolytically. It is also important to note that these systems can be made to be liquids or low melting solids such that they can be cast or coated without solvents.

Thus, OPS/^{R}D₄-resin/Q and cage systems provide access to novel, inexpensive, and multifunctional coatings with tailorable mechanical and hydrophobic surface properties currently not accessible with most types of coating systems. Two routes (via addition of modified D₄ or other SQs or Qs) permit introducing other functional groups e.g. vinyl and SH groups to improve mechanical properties and/or chemical compatibility or abrasion resistance or resistance to UV aging etc.

The following examples are used in support of this invention.

### EXAMPLE 1

Synthesis of Mixed Phenyl:Me (10:1) Silsesquioxane Resins. Octaphenylsilsesqui-oxane [OPS, 10.00 g, 9.7 mmol (77.4 mmol phenyl)] was added to a dry 250 mL round bottom flask equipped with magnetic stirrer. THF (200 mL) was added and the mixture stirred for 5 mins. Octamethylcyclotetrasiloxane [^{Me}D₄, 0.33 mL, 1.08 mmol (8.64 mmol CH₃)] was added via syringe followed by 2.0 mL TBAF (2.0 mmol). The reaction mixture was stirred for 2 d at RT until the reaction mixture turned clear. The insolubles were then gravity filtered and the filtrate was removed under reduced pressure to give a viscous clear liquid (9.60 g, 93% with respect to total initial mass of reactants). IR: υC═H (3073-3006), υC—H (2961-2905), υC═C (Ar ring, 1594), υC═C (Ar ring, 1430), υSi—CH₃ (1259) υSi—O (1131-1011), υSi—CH₃ (841), υSi—C (796) cm⁻¹.

### EXAMPLE 2

Synthesis of Mixed Phenyl:Me (1:10) Silsesquioxane Resins. OPS [3.48 g, 3.37 mmol (27.0 mmol phenyl)] was added to a dry 250 mL round bottom flask equipped with magnetic stirrer. THF (200 mL) was added and the mixture stirred for 5 mins. ^{Me}D₄ [10.45 mL, 33.7 mmol (270.0 mmol CH₃)] was added via syringe followed by 2.0 mL TBAF (2.0 mmol). The reaction mixture was stirred for 2 d at RT until the reaction mixture turned clear. The insolubles were then gravity filtered and the filtrate was removed under reduced pressure to give a viscous clear liquid (13.05 g, 97% with respect to total initial mass of reactants). IR: υC═H (3073-3006), υC═H (2961-2905), υC═C (Ar ring, 1594), υC═C (Ar ring, 1430), υSi—CH₃ (1259) υSi—O (1131-1011), υSi—CH₃ (841), υSi—C (796) cm⁻¹.

Identification of the structures is presented in Example 3. Table of values here (None have Ag+) all straight cages.

### EXAMPLE 3

Synthesis of Mixed Phenyl:Me (1:1) Silsesquioxane Resins. OPS [34.80 g, 33.7 mmol (270.0 mmol phenyl)] was added to a dry 250 mL round bottom flask equipped with magnetic stirrer. THF (200 mL) was added and the mixture stirred for 5 mins. ^{Me}D₄ [10.45 mL, 33.7 mmol (270.0 mmol CH₃)] was added via syringe followed by 2.0 mL TBAF (2.0 mmol). The reaction mixture was stirred for 2 d at RT until the reaction mixture turned clear. The insolubles were then gravity filtered and the filtrate was removed under reduced pressure to give a viscous clear liquid (42.55 g, 95% with respect to total initial mass of reactants). TGA (air, 1000° C.): found 23.7%; T_{d5%}=358° C. IR: υC═H (3073-3006), υC═H (2961-2905), υC═C (Ar ring, 1594), υC═C (Ar ring, 1430), υSi—CH₃ (1259) υSi—O (1131-1011), υSi—CH₃ (841), υSi—C (796) cm⁻¹.

MALDI-ToF mass spectral analysis of this reaction solution shows the pattern shown in FIG. 14.

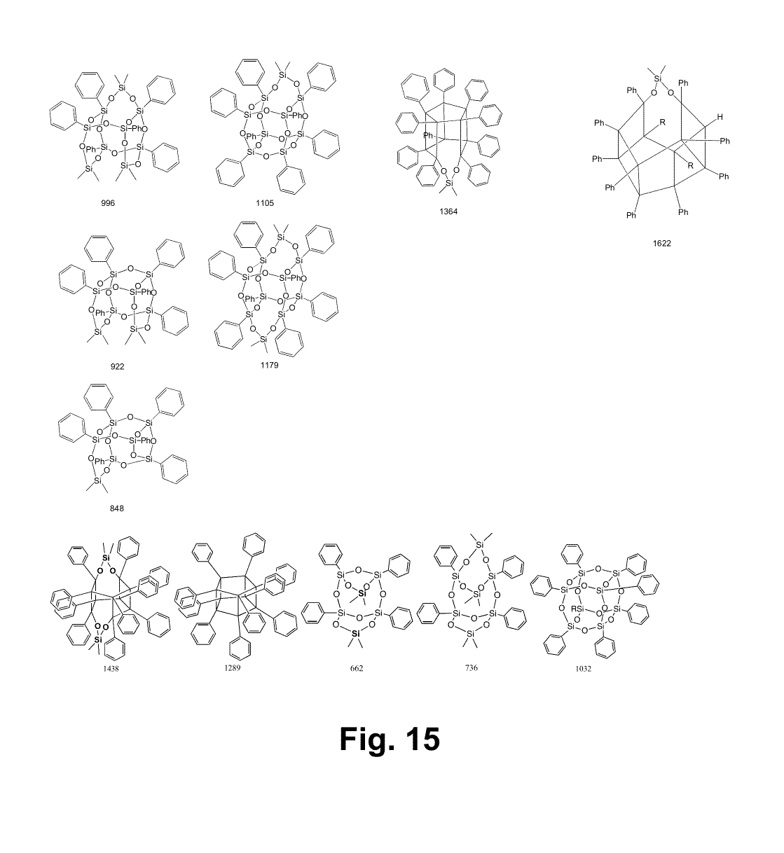

FIG. 15 shows almost all structures in Ph/^{Me}D.

### EXAMPLE 4

Synthesis of Mixed Phenyl:Me:CF₃CH₂CH₂— (6.5:5:1) Silsesquioxane Resins. OPS [26.11 g, 25.3 mmol (202.4 mmol phenyl)] was added to a dry 250 mL round bottom flask equipped with magnetic stirrer. THF (200 mL) was added and the mixture stirred for 5 mins. ^{Me}D₄ [4.71 mL, 15.2 mmol (121.6 mmol CH₃)] and (3,3,3-trifluoro-propyl)methylcyclo-trisiloxane [3.94 mL, 10.4 mmol (31.2 mmol -CH₂CH₂CF₃) was added via syringe followed by 2.0 mL TBAF (2.0 mmol). The reaction mixture was stirred for 2 d at RT until the reaction mixture turned clear. The insolubles were then gravity filtered and the filtrate was removed under reduced pressure to give a viscous clear liquid (33.4 g, 94% with respect to total initial mass of reactants). IR: υC═H (3073-3006), υC═H (2961-2905), υC═C (Ar ring, 1594), υC═C (Ar ring, 1430), υSi—CH₃ (1259), υC-F (1209), υSi—O (1131-1011), υSi—CH₃ (841), υSi—C (796) cm⁻¹.

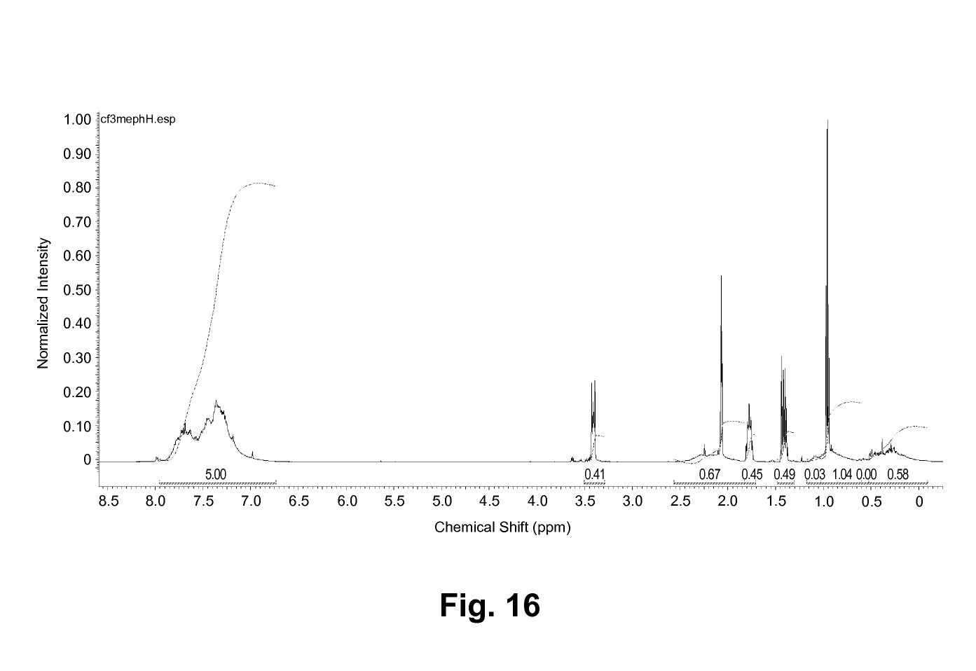

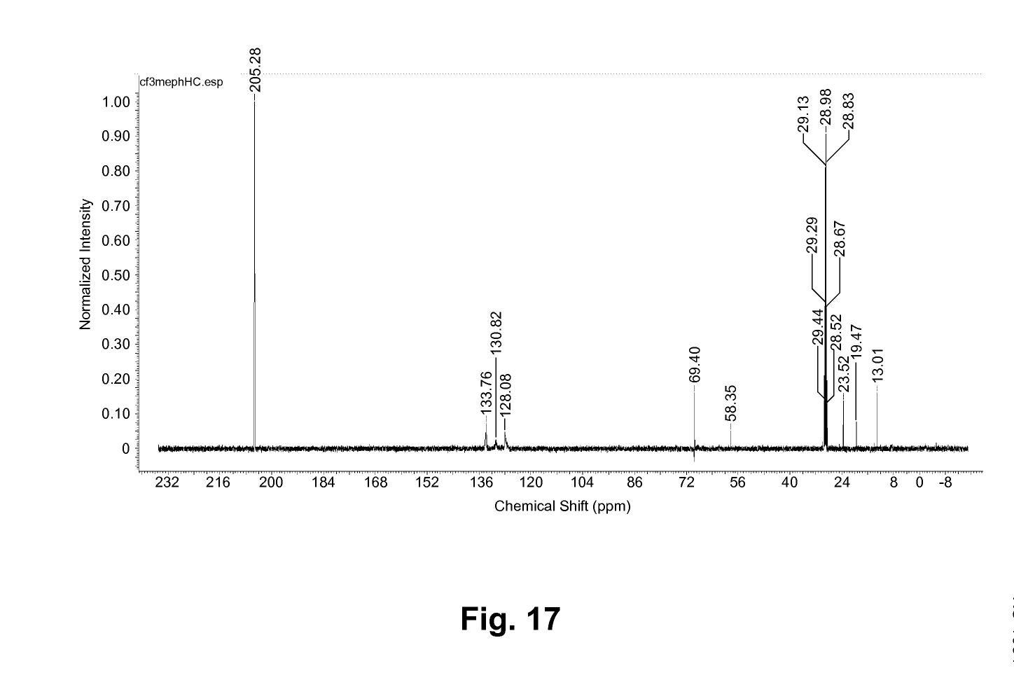

NMR analysis of the reaction solution gives the spectra shown in FIG. 16: ¹H NMR shows peaks in the aromatic C═H region from 7-8.0 ppm. The peak is assigned to

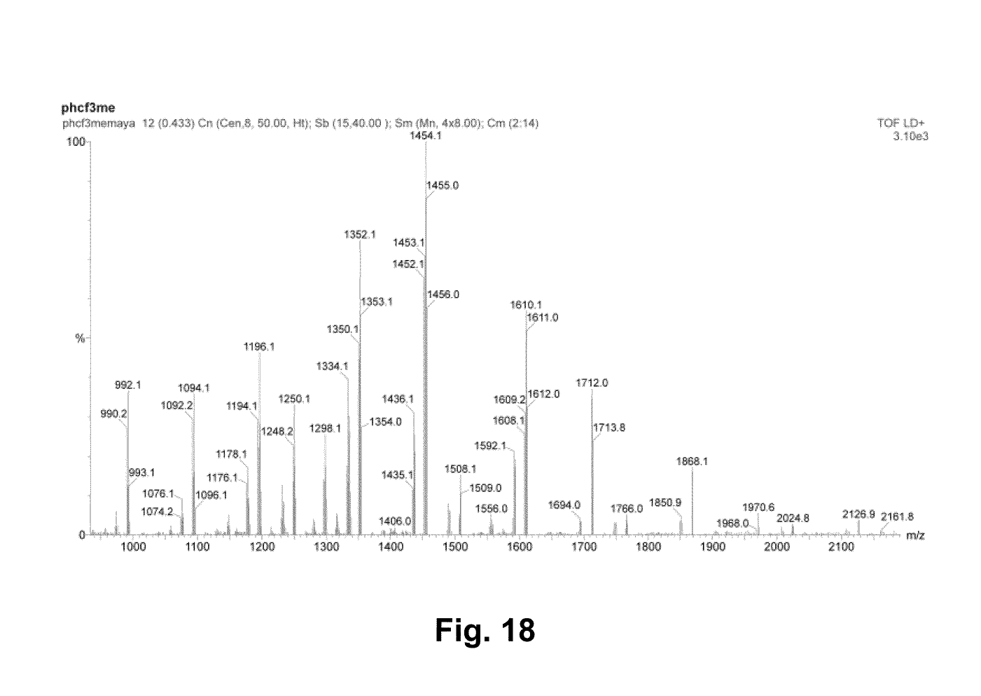

¹³C NMR shows peaks in the 120-136 ppm aromatic C region. Peaks at 13-19 are for aliphatic carbons. The MALDI-ToF mass spectral analysis of this reaction solution shows the pattern shown in FIG. 18.

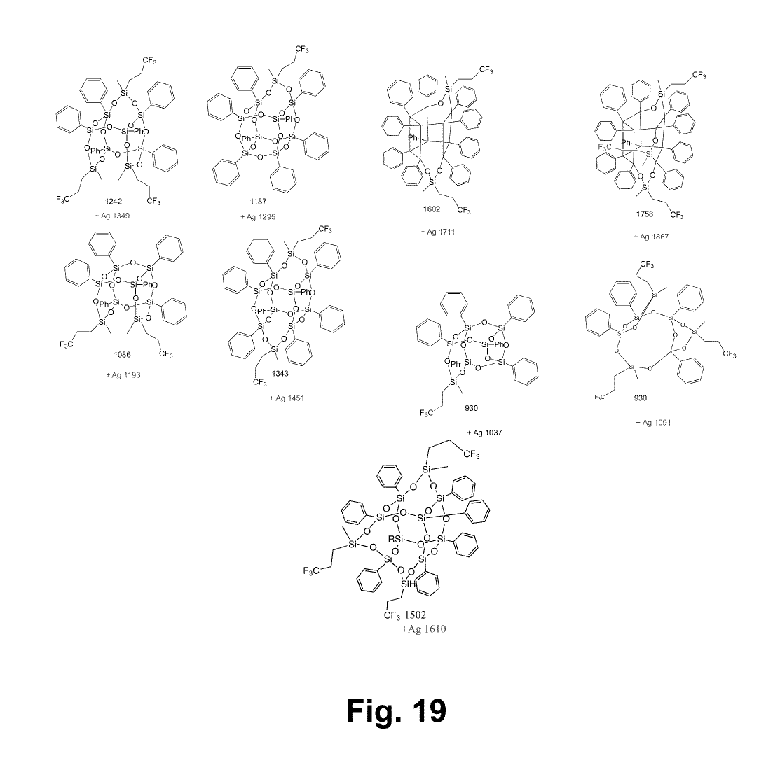

The various peaks in the Mass spectrum are easily analyzed and the suggested structures shown in FIG. 19 are suggested to account for the peaks seen.

Note that the mass spectral analyses can be off by one to two units due to the presence of water, different isotopes of Ag⁺.

These structures are unique and have never been seen before and represent new chemical compounds in equilibrium with polymeric versions of these compounds that form when the solvent is concentrated.

### EXAMPLE 5

Synthesis of Mixed Phenyl:Methacrylate (1:1) Silsesquioxane Resins. OPS [10.00 g, 9.7 mmol (77.4 mmol phenyl)] and octa[(methacryloylpropyl)dimethylsilyloxy] silses-quioxane [OMPS, 19.66 g, 9.7 mmol (77.4 mmol methacrylate)] was added to a dry 250 mL round bottom flask equipped with magnetic stirrer. THF (200 mL) was added and the mixture stirred for 5 mins. TBAF (2.0 mL, 2.0 mmol was added via syringe and the reaction mixture was stirred for 7 d at RT until the reaction mixture turned clear. The insolubles were then gravity filtered and the filtrate was removed under reduced pressure to give a viscous clear liquid (27.0 g, 91% with respect to total initial mass of reactants). IR: υC═H (3073-3006), υC═H (2956-2882), υC═O (1733), υC═C (Ar ring, 1430), υSi—CH₃ (1253) υSi—O (1132-1047), υSi—CH₃ (839), υSi—C (780) cm⁻¹.

### EXAMPLE 6

OG/Cyclohexanethioether-T_{10/12} (9:1) Rearrangement. OG (10.0 g, 5.179 mmol) and cyclohexanethioether-T_{10/12} (0.8993 g, 0.4187 mmol) were added to a 250 ml round bottom flask and dissolved in 100 ml of tetrahydrofuran (THF, 1.233 mol) to achieve a ratio of 1 sulfur eq per 9 epoxide eq. The flask was then equipped for magnetic stirring and plugged with a septum. Then, 2.0 ml of TBAF (1 M in THF, 6.785 mmol) was added via syringe. The reaction was stirred at RT for 24 h. Then, the solution was split into two samples. The THF from one sample was removed by rotary evaporation and further dried under vacuum at RT for 16 h. This sample still contained F—. The second sample was stirred with CaCl₂ (2.0 g, 18 mmol) for 24 h to capture the F—. The insoluble solid was filtered off. THF from the filtrate was removed by rotary evaporation and the product was further dried under vacuum at RT for 24 h.

### EXAMPLE 7

OG/Hexylthioether-T (9:1) Rearrangement. OG (10.0 g, 5.179 mmol) and hexylthioether-T (0.9085 g, 0.4185 mmol) were added to a 250 ml round bottom flask and dissolved in 100 ml of THF (1.233 mol) to achieve a ratio of 1 sulfur eq per 9 epoxide eq. The flask was then equipped for magnetic stirring and plugged with a septum. Then, 2.0 ml of TBAF (1 M in THF, 6.785 mmol) was added via syringe. The reaction was stirred at RT for 24 h. Then, the solution was split into two samples. The THF from one sample was removed by rotary evaporation and further dried under vacuum at RT for 16 h. This sample still contained F—. The second sample was stirred with CaCl₂ (2.0 g, 18 mmol) for 24 h to capture the F—. The insoluble solid was filtered off. THF from the filtrate was removed by rotary evaporation and the product was further dried under vacuum at RT for 24 h.

### EXAMPLE 8

OG/Cyclohexanethioether-T (1:1) Rearrangement. OG (2.5 g, 1.295 mmol) and cyclohexanethioether-T (2.0236 g, 0.9415 mmol) were added to a 250 ml round bottom flask and dissolved in 100 ml of THF (1.233 mol) to achieve a ratio of 1 sulfur eq per 1 epoxide eq. The flask was then equipped for magnetic stirring and plugged with a septum. Then, 2.0 ml of TBAF (1 M in THF, 6.785 mmol) was added via syringe. The reaction was stirred at RT for 24 h. Then, the solution was split into two samples. The THF from one sample was removed by rotary evaporation and further dried under vacuum at RT for 16 h.

This sample still contained F—. The second sample was stirred with CaCl₂ (2.0 g, 18 mmol) for 24 h to capture the F—. The insoluble solid was filtered off. THF from the filtrate was removed by rotary evaporation and the product was further dried under vacuum at RT for 24 h.

### EXAMPLE 9

OG/Hexylthioether-T (1:1) Rearrangement. OG (5.0 g, 2.590 mmol) and hexylthioether-T (4.0883 g, 1.883 mmol) were added to a 250 ml round bottom flask and dissolved in 100 ml of THF (1.233 mol) to achieve a ratio of 1 sulfur eq per 1 epoxide eq. The flask was then equipped for magnetic stirring and plugged with a septum. Then, 2.0 ml of TBAF (1 M in THF, 6.785 mmol) was added via syringe. The reaction was stirred at RT for 24 h. Then, the solution was split into two samples. The THF from one sample was removed by rotary evaporation and further dried under vacuum at RT for 16 h. This sample still contained F—. The second sample was stirred with CaCl₂ (2.0 g, 18 mmol) for 24 h to capture the F—. The insoluble solid was filtered off. THF from the filtrate was removed by rotary evaporation and the product was further dried under vacuum at RT for 24 h.

### EXAMPLE 10

OG/Cyclopentanethioether-T (1:1) Rearrangement. OG (5.0 g, 2.590 mmol) and cyclopentanethioether-T (3.7561 g, 1.883 mmol) were added to a 250 ml round bottom flask and dissolved in 100 ml of THF (1.233 mol) to achieve a ratio of 1 sulfur eq per 1 epoxide eq. The flask was then equipped for magnetic stirring and plugged with a septum. Then, 2.0 ml of TBAF (1 M in THF, 6.785 mmol) was added via syringe. The reaction was stirred at RT for 24 h. Then, the solution was split into two samples. The THF from one sample was removed by rotary evaporation and further dried under vacuum at RT for 16 h. This sample still contained F—. The second sample was stirred with CaCl₂ (2.0 g, 18 mmol) for 24 h to capture the F—. The insoluble solid was filtered off. THF from the filtrate was removed by rotary evaporation and the product was further dried under vacuum at RT for 24 h.

### EXAMPLE 11

OG/Octylthioether-T (1:1) Rearrangement. OG (5.0 g, 2.590 mmol) and octylthioether-T (4.6696 g, 1.883 mmol) were added to a 250 ml round bottom flask and dissolved in 100 ml of THF (1.233 mol) to achieve a ratio of 1 sulfur eq per 1 epoxide eq. The flask was then equipped for magnetic stirring and plugged with a septum. Then, 2.0 ml of TBAF (1 M in THF, 6.785 mmol) was added via syringe. The reaction was stirred at RT for 24 h. Then, the solution was split into two samples. The THF from one sample was removed by rotary evaporation and further dried under vacuum at RT for 16 h. This sample still contained F—. The second sample was stirred with CaCl₂ (2.0 g, 18 mmol) for 24 h to capture the F—. The insoluble solid was filtered off. THF from the filtrate was removed by rotary evaporation and the product was further dried under vacuum at RT for 24 h.

### EXAMPLE 12

OG/Butylthioether-T₁₀/₁₂ (1:1) Rearrangement. OG (5.0 g, 2.590 mmol) and butylthioether-T_{10/12} (3.5073 g, 1.883 mmol) were added to a 250 ml round bottom flask and dissolved in 100 ml of THF (1.233 mol) to achieve a ratio of 1 sulfur eq per 1 epoxide eq. The flask was then equipped for magnetic stirring and plugged with a septum. Then, 2.0 ml of TBAF (1 M in THF, 6.785 mmol) was added via syringe. The reaction was stirred at RT for 24 h. Then, the solution was split into two samples. The THF from one sample was removed by rotary evaporation and further dried under vacuum at RT for 16 h. This sample still contained F—. The second sample was stirred with CaCl₂ (2.0 g, 18 mmol) for 24 h to capture the F—. The insoluble solid was filtered off. THF from the filtrate was removed by rotary evaporation and the product was further dried under vacuum at RT for 24 h.

### EXAMPLE 13

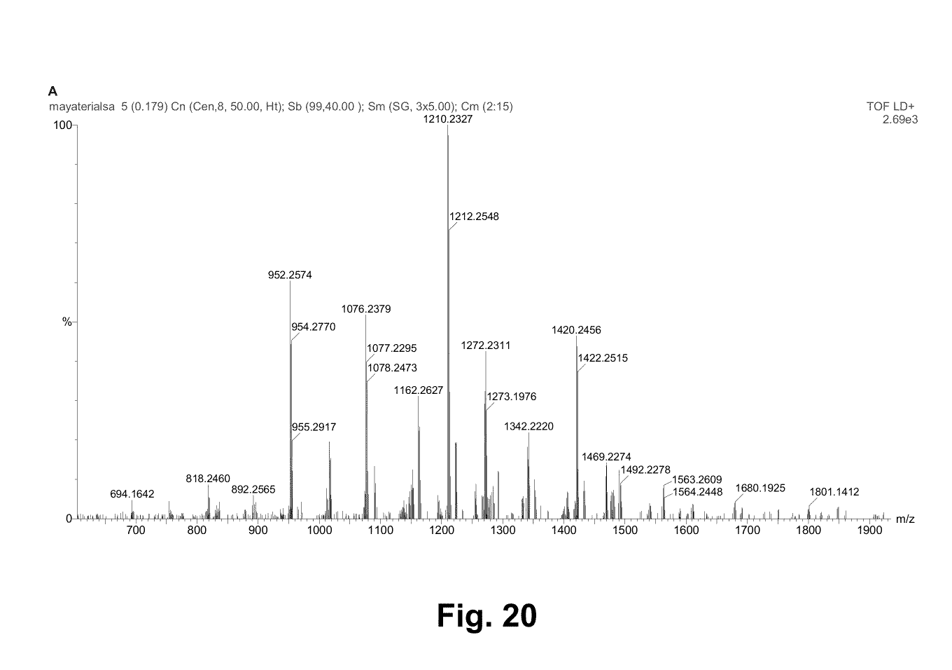

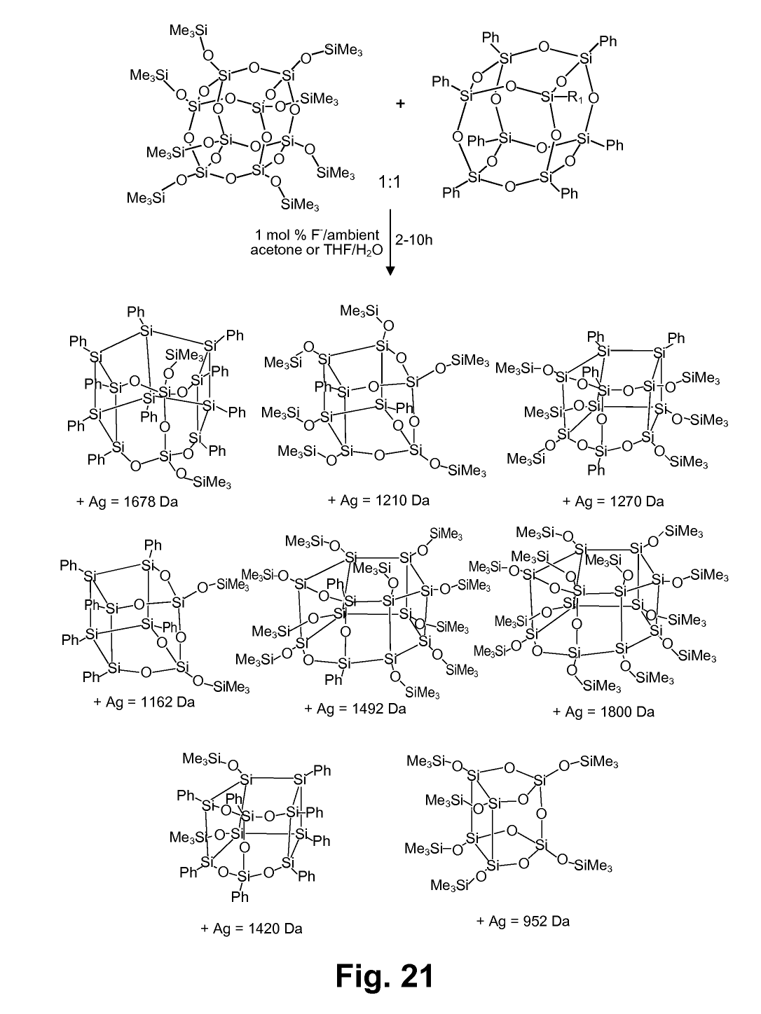

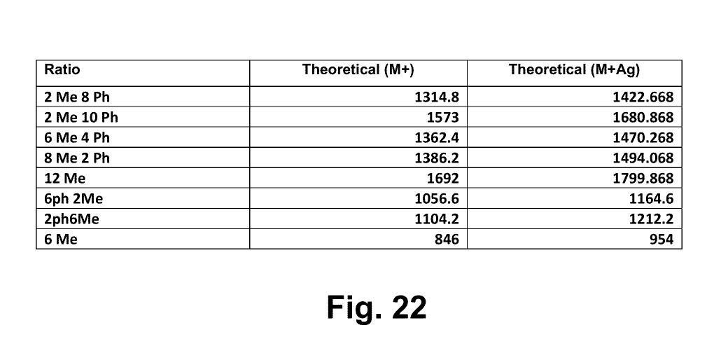

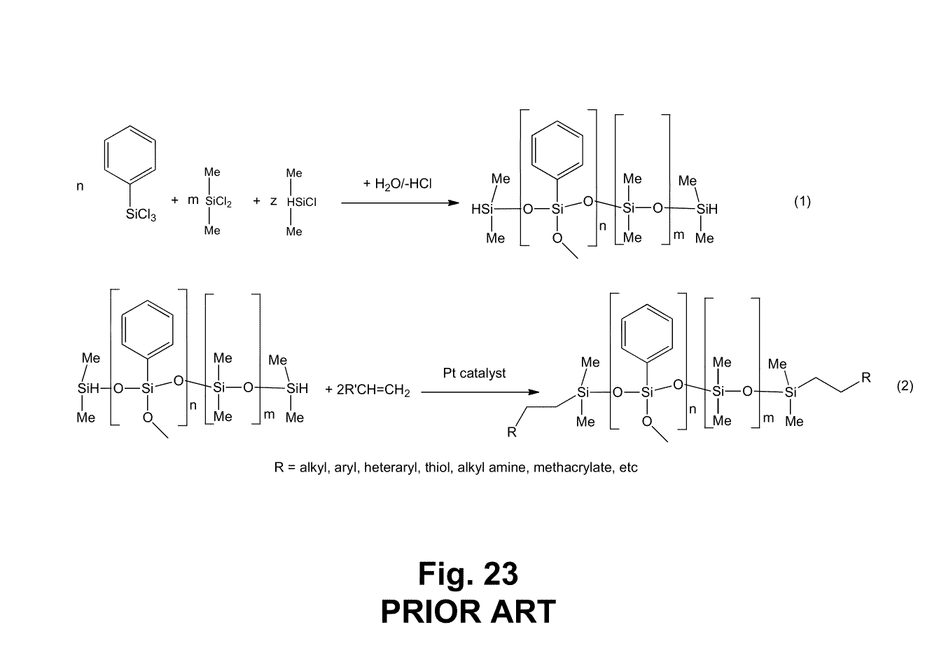

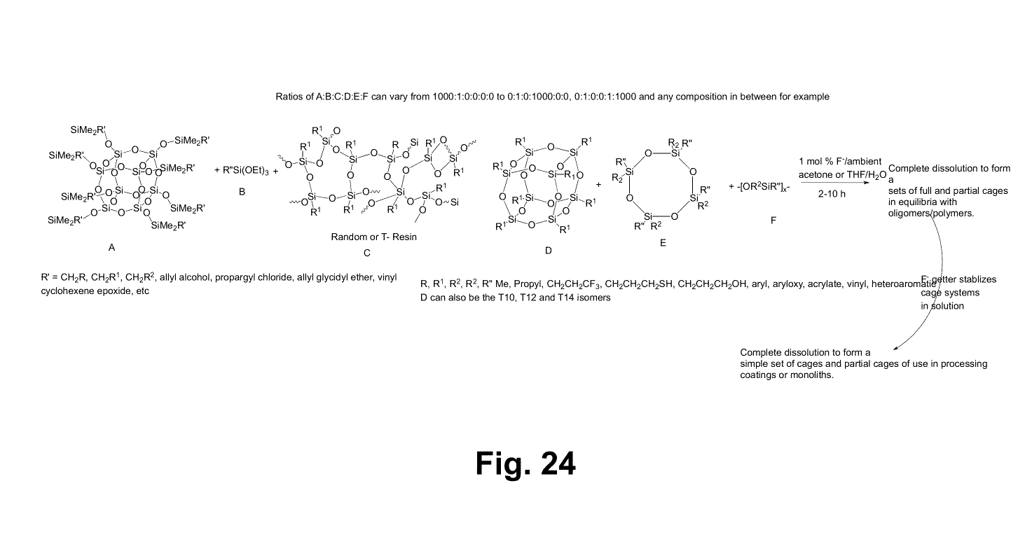

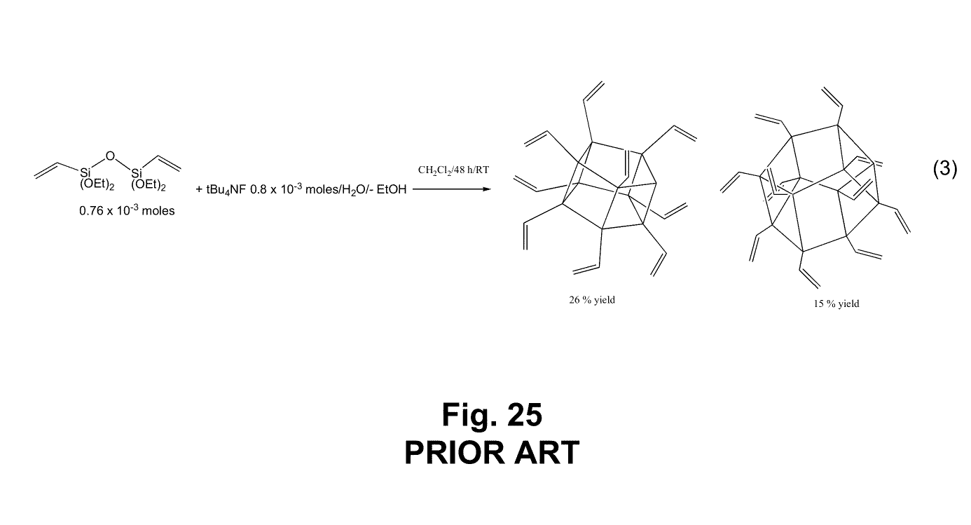

Synthesis of Mixed [PhenylSiO_{1.5}]₈:[Me₃SiOSiO_{1.5}]₈ (1:1) Silsesquioxane Q resins. OPS [3.80 g, 3.3 mmol (2.7 mmol phenyl)] was added to a dry 250 mL round bottom flask equipped with magnetic stirrer. THF (50 mL) was added and the mixture stirred for 5 mins. [Me₃SiOSiO_{1.5}]₈ [3.38, 3.0 mmol] was added via syringe followed by 2.0 mL TBAF (2.0 mmol). The reaction mixture was stirred for 2 d at RT until the reaction mixture turned clear. MALDI-ToF mass spectral analysis of this reaction solution shows the following pattern. Although equal amounts of phenyls are introduced the ionizable species favor products with more Me₃SiOSiO_{1.5} components. The suggested structures for a number of peaks are presented in FIG. 20.

Note that in all cases above, the MALDI-ToF Mass spectral analysis shows the presence of only those species that are ionizable under the analytical conditions. The intensities of the given peaks are not uniform across the spectrum. In addition, peak positions can vary by ±2 daltons as the instrument, even when calibrated, shows some drift. Furthermore, the peaks that are seen represent components that are present in polymeric versions of the resulting reaction solution give that on concentration the F⁻ catalyst will promote the polymerization of the individual cages.

What is claimed is:

1. A method of forming a silsesquioxane/Q/siloxane polymer or oligomer system used to form coatings or monoliths, comprising the step of:
mixing silsesquioxane, Q, siloxane and alkoxysilane components having structures as presented below in ratios as presented below with a soluble F⁻ catalyst and water in a suitable solvent so that on stirring at temperatures of −20° to approximately 100° C. all of the components dissolve producing a solution,
wherein a soluble oligomer is formed in equilibribum with single molecules with specific structures including [RSiO_{1.5}]ₓ[R′MeSiO]_{y}[R′Me₂SiOSiO_{1.5}]_{z} (where R═R′ or R″ or R¹ or R² as denoted below) and where x, y and z are mole fractions whose sum is equal to one.

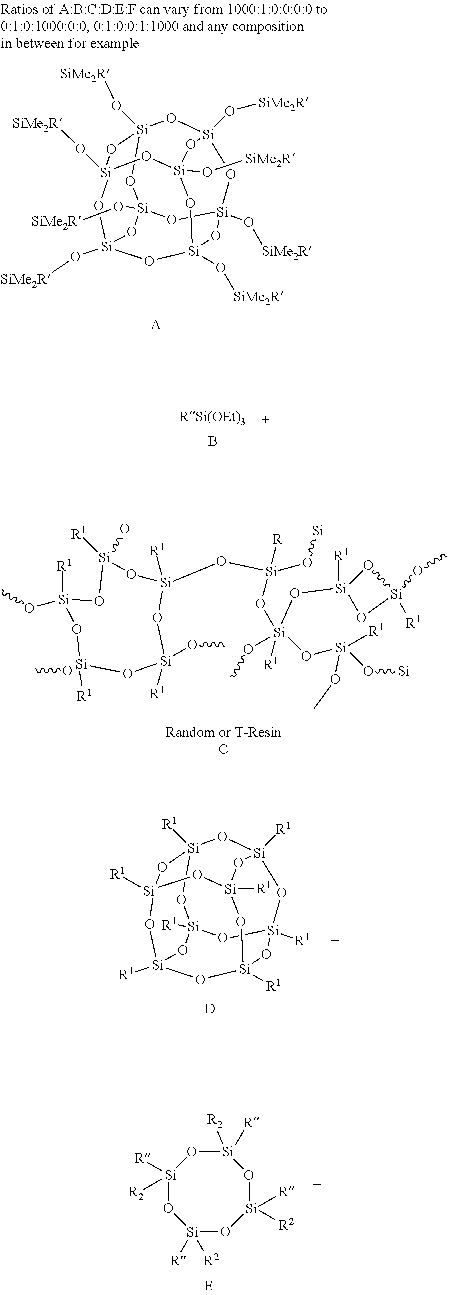

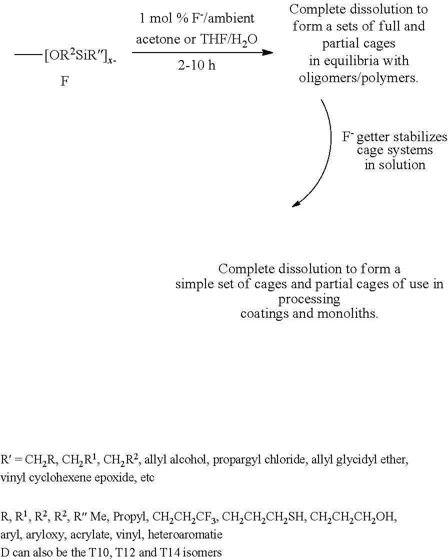

2. The method of claim 1, further comprising the step of adding a component including nanoparticles to modify functional groups to optimize specific properties including ability to photolytically or thermally crosslink, adhesive and mechanical strength, fracture toughness, refractive indices, surface hydrophobicity or hydrophilicity or to introduce components that will phase separate in a coating or monolith so that the system can then be cast or coated and cured to form coatings, films, monoliths or used as an additive.

3. The method of claim 1, wherein the silsesquioxane can be a T₈, T₁₀, T₁₂ or T₁₄ single cage or mixed cages or a random resin where R, R¹, R² are chosen from those listed above.

4. The method of claim 1, wherein the Q species can be a Q₈ or Q₁₀ single cage or mixed cages or a random Q resin where R′ is chosen from those listed above.

5. The method of claim 1, wherein the siloxane unit —[RSiR′O]n- can be a cyclomer where n=3-8 or a linear or branched oligomer or polymer where R₁,R″ can be the same or different and can be chosen from those listed above.

6. The method of claim 1, wherein the alkoxy silane component(s) R″ can be chosen from those listed above, and the alkoxy group can be Et as shown or methoxy or other alkoxy group or also acetate or other carboxylate.

7. The method of claim 1, wherein the suitable solvent can be acetone, alcohols, ethyl acetate, dichloromethane, acetonitrile, THF, methylethyl ketone, dimethoxyethane (glyme), diglyme, dioxane and small amounts of water or other types of solvents that will dissolve all of the components at least partially.

8. The method of claim 1, wherein a suitable temperature is between −20° C. and 100° C. but preferably between about 0° C. and 50° C. to avoid F⁻ promoted cleavage of Si—C bonds.

9. The method of claim 1, wherein a suitable temperature is most preferably between about 10° and 40° C. to avoid F⁻ promoted cleavage of Si—C bonds.

10. The methods of claim 1, wherein the source of F⁻ is R₄NF or R₄PF where R is all the same alkyl group or mixed alkyls or aryl alkyls or where F⁻ is part of a salt with some non-coordinating cation such that the species is soluble in multiple organic solvents or can be used at the interface between a non-solvent and a good solvent.

11. The method of claim 1, wherein the F⁻ catalyst is left in to provide on coating or casting an oligomeric or polymeric mixture containing all of the components.

12. The method of claim 1, wherein the F⁻ catalyst is removed by stirring the solution with an F⁻ getter that can be CaCl₂ or MgCl₂ or related compounds or those containing Si—H bonds where this compound does not depolymerize or react otherwise with the other components under the reaction conditions to provide a coating or casting system containing cage species with functionality of all of the initially added components.

13. The method of claim 1, wherein the F⁻ catalyst is removed by washing with water or some other suitable solvent not miscible with the first solvent.

14. The method of claim 11, wherein the solution is applied to a substrate by dipping, spraying, roller or brush coating to provide an even coating that when dried can be heated from 20° C. to greater than 300° C. to form Si—O or C—C crosslinks that provide suitable adherence to the substrate with controlled surface mechanical, photonic and/or electronic properties.

15. The method of claim 10, wherein the solution is cast to provide a monolith that when dried by vacuum evaporation or heating from 20° C. to greater than 300° C. forms Si—O or C—C crosslinks that provide suitable mechanical properties in a stand-alone monolith.

16. The method of claim 1, wherein the product is a liquid or low melting solid that can be used without solvent to provide coatings or monoliths.

17. The method of claim 1, wherein the coatings or monoliths or additives are thermally or photolytically crosslinked using “ene-thiol” reactions.

18. A composition for forming a coating or a monolith, comprising:
a silsesquioxane component;
a siloxane component;
an alkoxysilane component; and
an F⁻ catalyst,
wherein said silsesquioxane component, said siloxane component, and said alkoxysilane component have structures as presented below in ratios as presented below: 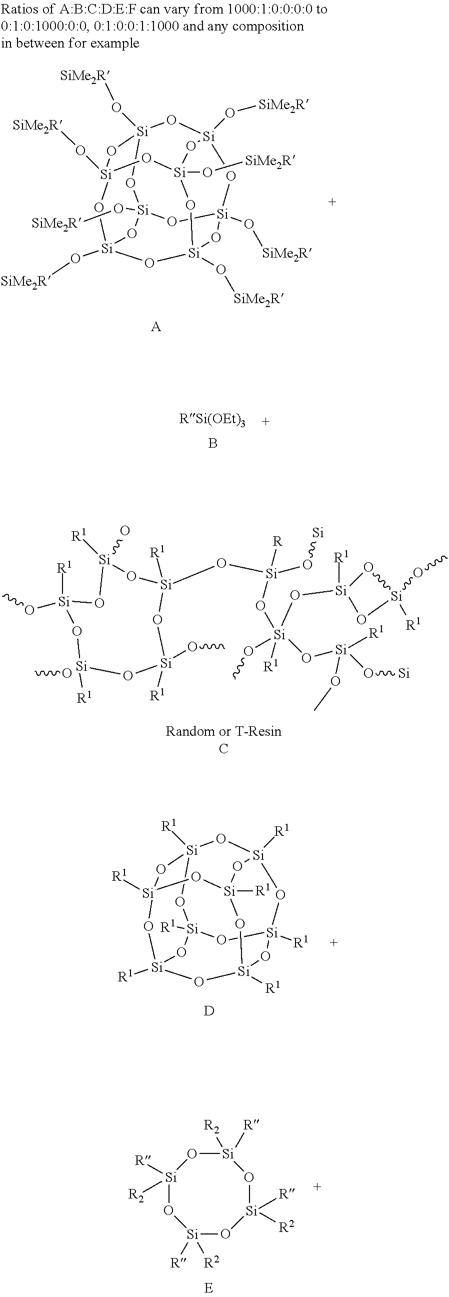 [chemical structure]
